(19) United States
(12) Patent Application Publication
(10) Pub. No.: US 2008/0156056 A1
(43) Pub. Date: Jul. 3, 2008

(54) Method and Device for Producing a Knurl on the Suface of a Workpiece

(75) Inventor: Christoph Schroder, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/912,396

(22) PCT Filed: Mar. 20, 2006
(86) PCT No.: PCT/EP06/02517

§ 371 Date: Oct. 24, 2007

(30) Foreign Application Priority Data
Apr. 28, 2005 (DE) 10 2005 019 693.4

(51) Int. Cl. B23P 9/02

(52) U.S. Cl. 72/108; 72/121

(57) ABSTRACT

A method and a device to produce a knurl (2) on a surface or part of a metallic disk (1) or a friction wheel which are produced from sheet metal (13) through a drawing process are provided. The structure (7) of the knurl (2) is stamped or rolled onto the sheet metal prior to or after forming the sheet metal (13), in order to prevent sharp-edged knurl structures. The structure is produced with the aid of a stamping element (6) which is provided with the structure (7) or by a knurling cylinder (9) which is also provided with the structure (7), which can be pressed against the surface of the sheet metal (13) of the disk (1) or the friction wheel.

### BACKGROUND

The invention relates to a method and to a device for producing a knurl on the surface of a workpiece, preferably, a metallic guide pulley for a belt drive or a friction wheel, which is subjected to a shaping process, in particular, a drawing process.

Knurling is understood to be the imprinting of patterns on handles of tools, screws, clip nuts, components, and the like. In this way, the tools or components are gripped more easily in the hand and do not easily slip when handled. Steel guide pulleys with defined track geometry on their gripping surface, which can be used for different applications, are also known.

In addition, guide pulleys or friction wheels for non-metallic belt means of belt drives are also known, on whose outer peripheral surface the belt means run. Such a guide pulley or friction wheel sits with its internal diameter surface on the outer ring of a roller bearing, so that a fixed operating connection is guaranteed between these two components.

The knurling of the outer peripheral surface of the guide pulley is realized today typically by knurling cylinders, on whose periphery the knurling pattern is applied, which is transferred to the workpiece during the knurling. For example, a completely mounted steel guide pulley B with a bearing seat opening for a cylinder bearing is tensioned between two opposing knurling cylinders or knurling wheels C, as is shown, for example, in FIG. 1. Both knurling wheels C have knurling patterns in half relief on the peripheral side, wherein the knurling pattern of one knurling cylinder runs in the opposite direction relative to the knurling pattern of the other knurling cylinder, so that cross knurling is realized on the workpiece to be knurled.

A disadvantage in known knurling methods is the resulting surface structure of the knurling pattern on the workpiece. Here, sharp-edged positions, which could lead to damage to the contact partner or contact element, for example, non-metallic belt means, are produced on the knurling structure. In particular, bulges deviating at the bottom and top in cross section from the middle form of the workpiece are produced, as shown in FIG. 2. Therefore, post-processing of the knurled surface structure by an additional smoothing or rolling process is necessary, in order to eliminate the sharp edges. In addition, there is the risk of deforming the workpiece, for example, the guide pulley, during the knurling and the subsequent smoothing or rolling.

### SUMMARY

The invention is based on the objective of providing a method and a device for producing a knurl structure on the surface of a workpiece of the type noted above, with which damage to a contact partner or contact element is prevented in the use of the workpiece or an object produced from this workpiece.

Consequently, the invention initially relates to a method for producing a knurl with a geometrically shaped or a randomly shaped or arbitrarily shaped structure. According to the invention, this structure is applied to the surface of one part of a metallic guide pulley or a friction wheel of a traction mechanism drive, which is produced from sheet metal in at least one shaping process. Here, it is provided that the knurling according to the invention is imprinted or rolled into the sheet metal before or after a first shaping process of the sheet metal.

This permits a production process, which allows a defined and above all non sharp-edged transition radius to the knurl recess. The imprinting or rolling of the knurl for duplicating the structure according to the invention is performed before or after a certain step of the shaping process through drawing of a metallic sheet-like workpiece. For example, the knurling can be performed before the drawing of this workpiece, if the knurling is introduced through imprinting. Through the subsequent drawing, the surface of the knurl is necessarily stretched and therefore smoothed. In principle, imprinting after prior drawing of the workpiece is also possible, wherein the knurling is dependent on the surface of the imprinting tool. For producing a randomly shaped surface of the knurl, for example, a programmable imprinting device is suitable, with which a constantly changing knurl structure can be produced.

The knurl according to the invention can also be realized in connection with or after a non-cutting drawing process, when the workpiece is later subjected to smoothing, for example, when rolling the knurl surface. In each case, a smoothed knurl surface is achieved, so that damage to the contact partner or contact element due to the knurled surface of a guide pulley or a friction wheel is prevented. In this way, an optimum target geometry of the recesses on the workpiece surface is achieved, so that no sharp-edged projections are produced.

According to an actual construction of the method, it can be provided that the knurl is produced after an opening for a bearing seat of the guide pulley or the friction wheel has already been punched in the sheet metal.

The sheet metal, on which the knurling is performed, can here have a round blank-shaped, that is, generally circular, construction, from which a guide pulley or a friction wheel is shaped after producing the knurl in one or more other production steps.

The knurl on the workpiece surface is produced according to a variant of the method by a press die with a work surface having a knurl, in which the die is pressed onto the surface of the workpiece.

Through this processing measure, if necessary, the knurl can be positioned in a defined, limited area of the round blank or the sheet metal.

According to another processing step, the round blank or the sheet metal is moved between at least one cylinder pair, wherein one of the cylinders is provided with the knurl. After rolling the knurl, the round blank or the sheet metal is also guided between a smoothing cylinder pair, in order to smooth the peaks of the knurl.

The rolling advantageously has no effect on the cycle time for producing the end products, as is the case, for example, in the press die method. The imprinting of the surface through rolling can also be performed over the entire surface area of the round blank or the sheet metal. Subsequently, smoothing, especially in a cut-out region of the workpiece, can then be performed.

Also for this processing step, after the rolling of the knurl, the round blank or the sheet metal can optionally be shaped in another drawing step preferably into a guide pulley for a belt drive or into a friction wheel.

Obviously, the method according to the invention can also be used for producing a knurled surface on the bearing seat of the guide pulley or a friction wheel, so that this surface guarantees an especially good hold on an outer surface of a bearing outer ring. The knurling is performed according to the presented method on the still flat sheet metal sections, which form the running surface of the guide pulley or the friction wheel and/or the bearing seat after the final shaping. Therefore, the knurling is performed before the workpiece is finally shaped for producing the guide pulley or the friction wheel.

The invention also relates to a device for generating a randomly shaped knurl on the surface of a part of a metallic guide pulley or a friction wheel, which are produced from sheet metal in at least one shaping process. This device is characterized in that a press die provided with knurling or a knurling cylinder provided with the knurling can be pressed against the surface of the sheet metal.

This device allows the performance of the production method named above and its embodiments, so that advantageously guide pulleys or friction wheels can be produced with this, which are not provided with a peripheral geometry deviating from the circular shape due to the knurling process.

In the device according to the invention with one knurling cylinder, a counter pressure cylinder is allocated to this knurling cylinder, wherein the round blank or the sheet metal can move between these two cylinders. In this way, a knurling cylinder pair is produced, between which the workpiece is guided and provided with the knurling.

According to another improvement of the device according to the invention, a smoothing cylinder pair is arranged after the knurling cylinder and the counter pressure cylinder in the production sequence. This smoothing cylinder pair provides for a certain amount of smoothing of the sharp-edged projections of the knurled surface of the workpiece possibly occurring due to the knurling cylinders.

### BRIEF DESCRIPTION OF THE DRAWINGS

The invention is explained in more detail below using embodiments with reference to the enclosed drawings. Shown therein are:

FIG. 1 a knurling device according to the state of the art,

FIG. 2 an enlarged partial section view of the knurling structure on a workpiece surface according to the state of the art,

FIG. 3 a top view of a round blank or sheet metal for producing a metallic guide pulley for a belt drive with knurled surface,

FIG. 4 a side view of a final metallic guide pulley with knurled running surface,

FIG. 5 an enlarged partial section view of the knurl structure of a workpiece produced with the method according to the invention,

FIG. 6 a schematic view of a knurling device with press die according to the invention, and

FIG. 7 a schematic view of a knurling device with a knurling cylinder according to the invention.

### DETAILED DESCRIPTION OF THE PREFERRED EMBODIMENTS

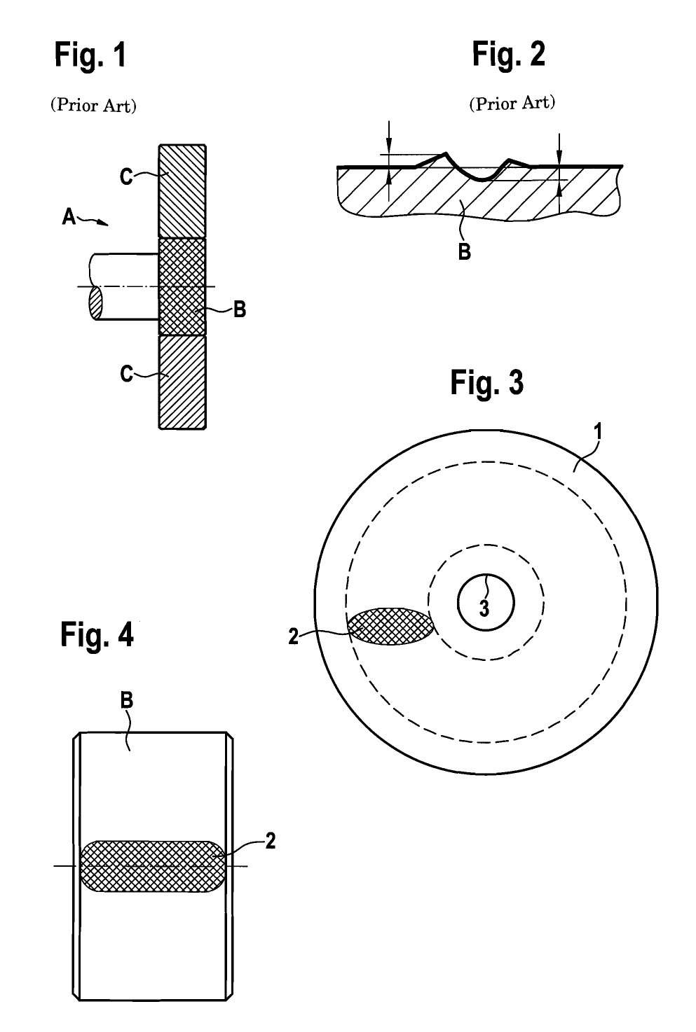

Accordingly, FIG. 1 shows as already briefly mentioned above, a knurling device A according to the state of the art. In this device, a cylindrical workpiece B, for example, a finished, mounted steel guide pulley with bearing seat opening for roller bearings is pressed between two opposing knurling cylinders or knurling wheels C. Through corresponding contact pressure of the counter rotating knurling cylinders or knurling wheels C, a knurling surface structure is created on the workpiece B or the guide pulley. This structure is enlarged in FIG. 2 and shown in cross section. This knurling has material bulges, which are marked by spaced arrows and whose sharp edges and/or height is undesired.

In FIG. 3, a sheet-metal round blank 1 is shown for producing a metallic guide pulley for a belt drive or a friction wheel, which has a knurl 2 shown only partially on its surface. The knurl 2 is created before or after a defined drawing process of a plurality of drawing processes, in which, for example, the bearing seat opening 3 is formed and/or the guide pulley geometry is generated, using a method according to the invention.

FIG. 4 shows a top view onto the track of the sheet-metal round blank 1, which is shaped into a guide pulley B and in which the knurl 2 is shown again only partially, but comprises the entire running surface.

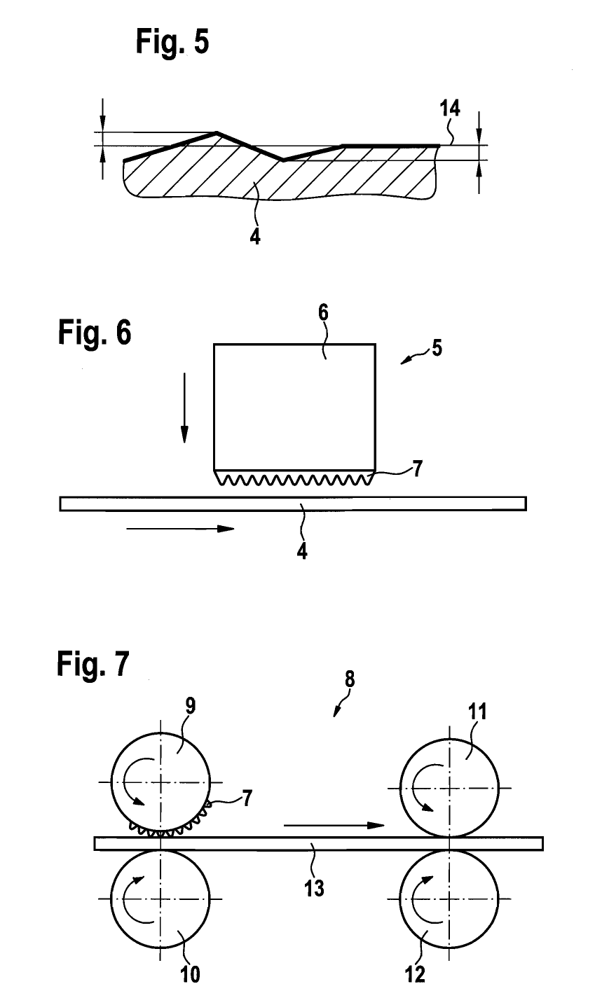

The enlarged partial section view of the knurl generated according to the invention from FIG. 5 of a workpiece 4 produced with the method according to the invention shows that the cross-sectional structure of the knurl has absolutely no sharp edges and thus cannot damage the contact partner or contact element. Nevertheless, the surface of this workpiece, that is, for example, the track of the guide pulley B, is advantageously roughened, as the four arrows pointing to each other make clear. For example, the raised sections are a maximum 48.6 μm high above an imaginary peripheral line 14 and the low sections are a maximum 45.1 μm deep relative to this peripheral line 14.

FIG. 6 shows schematically a knurling device 5 with a press die 6, in whose bottom side a structure 7 is formed. The press die 6 is moved downward at a given cycle in the perpendicular direction according to the vertical arrow and acts with a relatively large pressure on a horizontally fed workpiece 4 supported from below, for example, the sheet-metal round blank 1 for producing a guide pulley B for a belt drive. The press die 6 imprints the knurl 2 on the surface of the workpiece 4. The knurl is imprinted, for example, after the bearing seat opening 3 has been punched out in the sheet metal. When the knurl is imprinted by a press die 6, it is advantageous that the knurl 2 is realized geometrically very exact and without material bulging at the knurl 2 due to the opposing flat surfaces of the die 6 and sheet metal 4.

FIG. 7 shows another knurling device 8 shown schematically with a knurling cylinder 9, in whose outer periphery the structure 7 according to the invention is formed. A counter pressure cylinder 10 is allocated to the knurling cylinder 9, between which the sheet metal 13 is guided, in whose top side the knurl is imprinted under pressure. A sheet-metal round blank 1 can be stamped from this sheet metal 13.

Behind this rotating cylinder pair 9, 10 in the advancing direction, there is another rotating cylinder pair, which includes two opposing smoothing cylinders 11 and 12. Between these two named cylinder pairs 9, 10 and 11, 12, the sheet metal 13 is introduced for applying the knurl 2 and then smoothing it.

### LIST OF REFERENCE SYMBOLS

A Knurling device
B Workpiece; guide pulley
C Knurling cylinder
1 Sheet-metal round blank
2 Knurl
3 Bearing seat opening
4 Workpiece; sheet metal
5 Knurling device
6 Press die
7 Structure
8 Knurling device
9 Knurling cylinder
10 Counter pressure cylinder
11 Smoothing cylinder
12 Smoothing cylinder
13 Sheet metal
14 Peripheral line

1. Method for producing a knurl on a surface of a part of a metallic guide pulley or a metallic friction wheel, which are made from sheet metal in at least one shaping process, method of comprising imprinting or rolling the knurl, which has a geometrically shaped or a random or arbitrary structure into the sheet metal before or after a first shaping of the sheet metal.

2. Method according to claim 1, wherein the shaping process is a drawing process.

3. Method according to claim 1, wherein the knurl is generated after an opening for a bearing seat has been formed in the sheet metal (1, 4, 13).

4. Method according to claim 1, wherein the knurl is produced with the structure on a round blank-shaped workpiece which is subsequently shaped in one or more steps into the guide pulley or the friction wheel.

5. Method according to claim 1, further comprising forming the knurl and the structure using a press die, which is pressed onto a surface of the sheet metal.

6. Method according to claim 1, further comprising moving the sheet metal between at least one cylinder pair, wherein one of the cylinders includes a knurl, with which the structure can be produced.

7. Method according to claim 6, further comprising after rolling of the knurl for achieving the structure, moving the sheet metal between a smoothing cylinder pair.

8. Method according to claim 7, further comprising after the rolling of the knurl, shaping the sheet metal in a drawing step into the guide pulley for a belt drive or into the friction wheel.

9. Method according to claim 1, further comprising forming the knurl sections of the sheet metal that form a running surface or a bearing seat for the finished guide pulley or the finished friction wheel.

10. Device for producing a knurl on a surface of a part of a metallic guide pulley or a metallic friction wheel, which are produced from sheet metal at least one shaping process, comprising a press die or a knurling cylinder that is pressable against a surface of the sheet metals outer contours of the press die or knurling cylinder are shaped as the knurl.

11. Device according to claim 9, wherein the device comprises the knurling cylinder and a counter pressure cylinder is allocated to the knurling cylinder, such that the sheet metal can move between the two cylinders.

12. Device according to claim 10, wherein a smoothing cylinder pair is arranged after the knurling cylinder and the counter pressure cylinder, between which the knurled sheet metal can move.
